(19) United States
(12) Patent Application Publication
(10) Pub. No.: US 2005/0190662 A1
(43) Pub. Date: Sep. 1, 2005

(54) Read/write head for optical disk drive and optical disk drive comprising such a read/write head

(76) Inventor: Gerard Eduard Rosmalen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/510,787

(22) PCT Filed: Mar. 20, 2003
(86) PCT No.: PCT/IB03/01158

§ 371 Date: Oct. 12, 2004

(30) Foreign Application Priority Data
Apr. 15, 2002 (EP) 02076458.5

(51) Int. Cl. G11B 7/09

(52) U.S. Cl. 369/44.15; 369/53.28; 720/683

(57) ABSTRACT

A read/write head for a optical disk drive, comprises a lens holder (8), a support frame (11 12, 16), means (15) for suspending the lens holder (8) in the support frame which means constrain movement of the lens holder (8) relative to the support frame, allowing only an at least limited translation in a focussing direction (z), parallel to the optical axis of a lens (7) in the lens holder (8), an at least limited translation in a tracking direction (y), perpendicular to the focussing direction (z), and an at least limited rotation about an axis in a tangent direction (x), perpendicular to both the focussing and the tracking direction, and actuator means, comprising only two conductive focussing coils (9, 10) with a winding axis parallel to the focussing direction (z), each positioned relative to a magnetic circuit (11, 12) in such a way that a current flowing through a coil (9, 10) gives rise to a force between the lens holder (8) and the support frame in the focussing direction (z). The winding axes of the two focussing coils (9, 10) are positioned on opposite sides of a plane through the center of mass of the lens holder (8), and parallel to the focussing and the tangent direction. The focussing coils (9, 10) are spaced apart in the tangent direction (x).

The invention relates to a read and/or write head for an optical disk drive, comprising a lens holder, a support frame, means for suspending the lens holder in the support frame, which means constrain movement of the lens holder relative to the support frame, allowing only an at least limited translation in a focussing direction, parallel to the optical axis of a lens in the lens holder, an at least limited translation in a tracking direction, perpendicular to the focussing direction, and an at least limited rotation about an axis in a tangent direction, perpendicular to both the focussing and the tracking direction, and actuator means, comprising two conductive focussing coils with a winding axis parallel to the focussing direction, each positioned relative to a magnetic circuit in such a way that a current flowing through a coil gives rise to a force between the lens holder and the support frame in the focussing direction, the winding axes of the two focussing coils being positioned on opposite sides of a plane through the center of mass of the lens holder and parallel to the focussing and the tangent direction.

The invention also relates to an optical disk drive comprising such a read/write head.

An example of a read/write head of the type mentioned in the opening paragraph is known from U.S. Pat. No. 5,905,255. This document discloses an embodiment of an objective lens driver comprising a movable member. An objective lens, a lens holder, and a first and a second permanent magnet, fixed on the lens holder, constitute the movable member. The objective lens and the first and the second permanent magnet are disposed symmetrically about a plane of symmetry which extends through the center of gravity of the lens holder and is parallel to the focussing direction and the tangent direction. Four wire members are stretched parallel to the tangent direction between a holding member and the lens holder. First and second bobbins are vertically disposed on a fixed base so that they are located side by side in the tracking direction. They are formed by yokes comprising a magnetic plate, extending in the focussing direction and the tracking direction, around which are wound tracking coils having the winding axis in the tracking direction and focussing coils having the winding axis in the focussing direction.

The known arrangement has the disadvantage that the dimensions of the magnetic plates, the winding of the focussing coil around the tracking coil, and the positioning of the bobbins side by side in the tracking direction lead to a relatively large dimension in the tracking direction. In an optical disk drive, the read/write head is moved in a radial direction relative to the disk to be read or written. Its orientation is such that the tracking direction is aligned in this radial direction. As large an area of the disk as possible should be used for recording and reading data. However, the lens of a read/write head with large dimensions in the tracking direction cannot be moved close to the axis of rotation of the disk, since the driving arrangement used to rotate the disk will interfere with such a lens holder.

It is an object of the invention to provide a read and/or write head of the kind described in the preamble and a disk drive provided with such a head, wherein the position and inclination of the lens holder can be controlled, and which can have reduced dimensions in the tracking direction.

This object is achieved by the read/write head according to the invention, which is characterized in that the focussing coils are spaced apart in the tangent direction.

Because the focussing coils are spaced apart in the tangent direction, a more compact arrangement can be obtained, since the distance between the winding axes of the coils in the tracking direction can be made smaller than the outer dimensions of the coils without the coils making contact. At the same time, due to the arrangement of the coils on opposite sides of the plane parallel to the focussing and the tangent direction, a tilting action can be obtained when the two focussing coils are driven in anti-phase. The focussing coil configuration will generally be restricted to said two focussing coils.

An arrangement wherein the focussing coils are spaced apart in the tangent direction is known. However, in this known arrangement the focussing coils are both centered on the plane parallel to the focussing and the tangent direction, so that no tilting action is possible.

Preferably, the two focussing coils are point-symmetrically arranged relative to the center of mass of the lens holder.

This step reduces the susceptibility to excitation of resonance frequencies during operation of the read/write head.

Preferably, the two focussing coils are mounted on the lens holder.

This has the advantage that the influence of external electromagnetic fields, such as those of the motor driving the disk to be read from and/or written to, on the position and orientation of the lens holder is very small.

Preferably, each magnetic circuit comprises a yoke extending at least partly through the corresponding focussing coil along its winding axis.

This is a very compact arrangement, which takes up little space.

Preferably, each magnetic circuit forms a loop in a plane parallel to the focussing and the tangential direction and comprises an air gap through which the windings of the corresponding focussing coil can move, at least one radial coil being mounted on the lens holder and located in each air gap with a winding axis aligned with the flux through the magnetic circuit.

Thus, translations in the tracking direction can be controlled. Only one magnetic circuit is used on each side of the lens holder for all three types of actuation mentioned. The manner in which focussing coils and radial coils are driven determines the position and orientation of the lens holder, that is, within the constraints provided by the means via which the latter is suspended in the support frame.

According to a further aspect of the invention, there is provided an optical disk drive comprising a read/write head according to any one of the claims 1-10.

In such a disk drive, disks can be read and/or written close to the center of rotation of the disk due to the compact dimensions of the read/write head in the tracking direction.

The invention will now be explained in further detail with reference to the accompanying figures, in which:

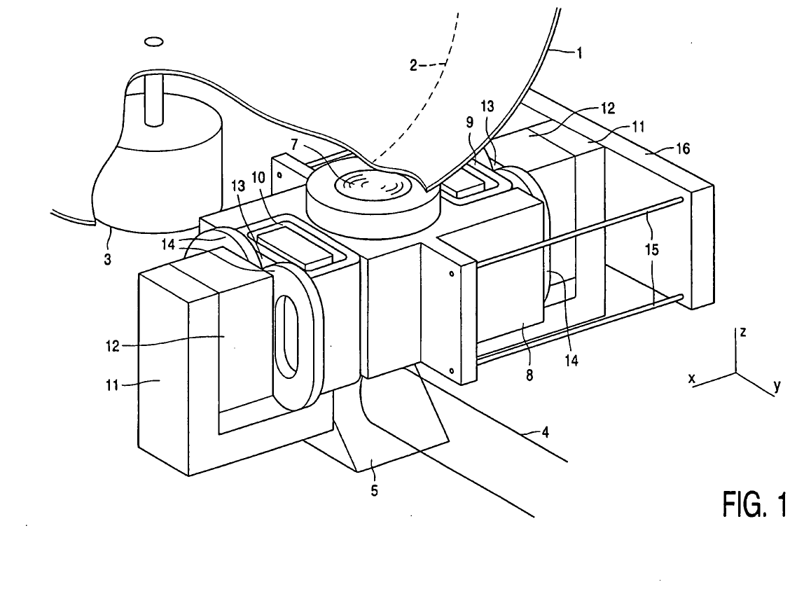

FIG. 1, is a diagram of the read/write head during reading from and/or writing to a disk;

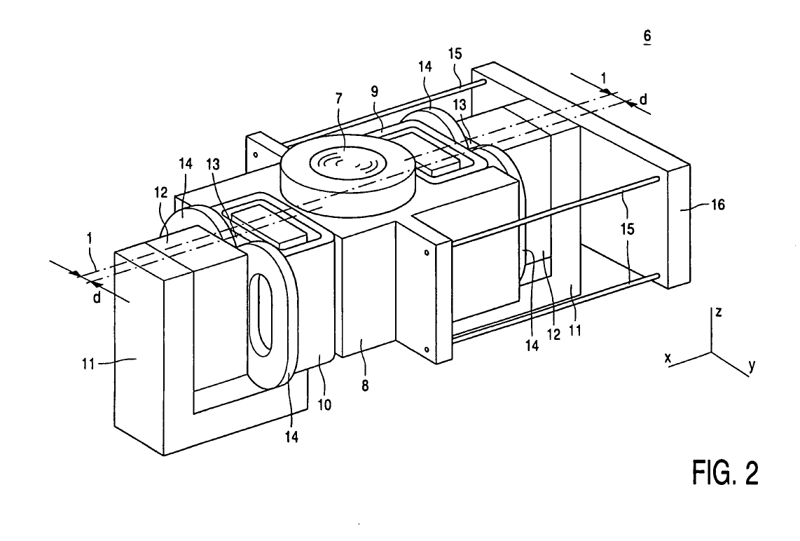

FIG. 2, is a diagram of the read/write head; and

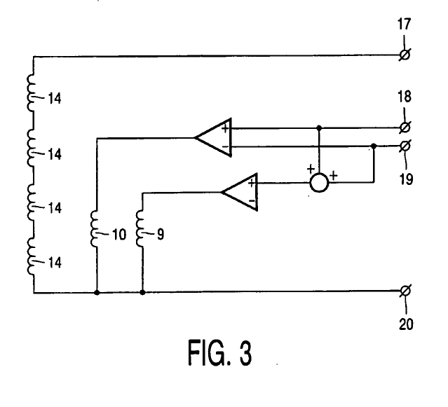

FIG. 3, is a diagram of a circuit enabling control of the orientation and position of the lens holder.

In an optical disk drive, information is encoded in one or more layers of an optical disk 1, which is shown schematically in FIG. 1. Various principles are known, each variant being suitable for use in conjunction with the invention. The information is laid down in one or more information tracks 2 in digital form. The variation of (optical) properties along the information track 2 contains the information recorded on the disk 1. To read the disk 1, it is rotated by means of a disk drive motor 3. The disk 1 is read by detection of light reflected in the disk 1.

In the example of the FIGS. 1 and 2, a light beam 4 is reflected in the direction of the disk 1 by means of a mirror 5 which is part of a read/write head 6. This description will use the term read/write head, since many disk drive systems allow information to be written to the disk 1 optically. The light beam 4 will then have a different power level and/or wavelength, but must also be focussed onto a point in the disk l, as is the case when the disk 1 is being read. The read/write head 6 is intended for focussing a beam onto the disk 1 for either reading or writing or both. Parts of the read/write head 6 that are relevant to the explanation of the invention are shown in the FIGS. 1 and 2. Light reflected by the mirror 5 is focussed onto the disk 1 by means of an objective lens 7 situated in a lens holder 8.

In a typical optical disk system, the information tracks 2 are very closely spaced in the radial direction, in order to fit as much information as possible onto the disk 1. In a Compact Disk (CD) the distance is 1.6 μm, while in a Digital Versatile Disk (DVD) the distance is 0.74 μm. There is a tendency towards smaller track distances in newer systems, as sources of (laser) light of smaller wavelengths and objective lenses 7, or lens systems, with a higher numerical aperture become available. In the configuration shown in FIG. 1, the light beam 4 is aligned in a radial direction relative to the disk 1. The position and orientation of the mirror 5 and the objective lens 7 determine the point on the disk 1 at which the light is focussed. Smaller distances between successive information tracks 2 are made possible by more accurate actuator arrangements for controlling the position and orientation of the read/write head 6.

The position of the read/write head 6 as a whole in the radial direction of the disk 1 may be controlled by means of a worm wheel acting on a slide or sledge (not shown) and driven by a sledge motor (not shown). However, fine-tuning of the position of the focussing point in the disk 1 is then carried out by adjusting the position of the lens holder 8 relative to the rest of the read/write head 6. To this end, the read/write head 6 comprises a support frame which is fixed to or forms part of the sledge.

The lens holder 8 is suspended in the support frame in such a way that its movement relative to the support frame is constrained. Referring to FIG. 1, the lens holder 8 is first of all capable of carrying out translations in a focussing direction z. That is, it can be moved closer or further away from the disk 1. In this way, the exact point in the disk 1 on which the light is focussed can be adjusted. Secondly, the lens holder 8 can carry out translations in a tracking direction y. By varying the position of the lens holder 8 in the tracking direction, the position on which the light beam 4 is focussed can be moved further or closer to the center of the disk 1. Thirdly, the lens holder 8 can be tilted, i.e. it can carry out rotations about a tangent direction x. In this way, the light beam 4 can be focussed on the disk 1 in such a way that it is always locally perpendicular to the surface of the disk, despite any inclination of the disk.

The adjustment of the position and the orientation of the lens holder 8 is used to adjust for small geometric deviations in the disk 1 or in the information track 2. In particular, deviations from a perfect plane—an “umbrella-like” shape—can be compensated for by varying the degree of tilt and the position in the focussing direction. The possibility of translating the lens holder 8 in the tracking direction y makes it possible to compensate for deviations from a spiral or circular shape of the information track 2. This becomes more important as a lens 7 with a higher numerical aperture is used. Such a lens can be positioned closer to the disk and makes it possible to read a disk 1 with narrow and closely spaced information tracks 2.

For accurate control of the position and the orientation, the read/write head 6 comprises an actuator arrangement and a control circuit (not shown). The control circuit provides the driving signals for the actuator arrangement. It is not considered part of the invention and a multitude of possible implementations of a control circuit for this purpose are known, so that no further description is given of the control circuit.

The actuator arrangement comprises only two focussing coils, viz. a first focussing coil 9 and a second focussing coil 10. The winding axis of each coil is parallel to the focussing direction z. The focussing coils 9, 10 are fixed to the lens holder 8. A magnetic circuit is provided for each of the focussing coils 9, 10. This magnetic circuit comprises a yoke 11 and a permanent magnet 12. Of course, a yoke and an electromagnet could also be used in principle.

A current flowing through one of the focussing coils 9, 10 will give rise to a force in the focussing direction z. Turning to FIG. 2, it will be more clearly appreciated that the first and second focussing coils 9, 10 are positioned on opposite sides of a plane through the center of mass of the lens holder 8 and parallel to the focussing direction z and the tangent direction x. The dashed line I lies in this plane. Due to such positioning, an unbalance between the forces generated when the first and second focussing coils 9, 10 are driven will result in a tilting action of the lens holder 8.

It will be apparent from FIG. 2 that the first and second focussing coils 9, 10 are quite large relative to the dimensions of the lens holder 8. The windings must be quite large to capture enough magnetic flux to generate the required force. Alternatively, of course, the height of the coils 9, 10 and the number of windings could be increased, but this is undesirable since the lens holder 8 must be as flat as possible and should have a low mass. The current could also be increased, but this would lead to the development of heat and, consequently, a lower efficiency. To achieve a compact lens holder 8, therefore, the first and second focussing coils 9, 10 are spaced apart in the tangent direction x, that is in this case at opposite ends of the lens holder 8. This enables the winding axes to be positioned closer to the plane through the center of mass of the lens holder 8. Note that the distance d between the plane through the center of mass of the lens holder 8 and the line 1 is smaller than the distance from the winding axis to the outer edge of the winding of the focussing coils 9,10 in a lateral direction parallel to the tangent direction. This is only possible because the focussing coils 9, 10 are spaced apart in the tangent direction. The compact construction of the read/write head 6 makes it possible to move the read/write head 6 closer to the center of the disk 1. This means that a larger area of the disk l close to the center becomes available for storing information.

As may be summarized from FIG. 2, the focussing coils 9, 10 are point-symmetrically arranged relative to the center of mass of the lens holder 8. They are not only arranged at equal distances to a plane through the center of mass and parallel to the focussing direction z and the tangent direction x, but also at equal distances to a plane through the center of mass and parallel to the focussing direction z and the tracking direction y. Although measures, to be described below, have been taken to dampen oscillation of the lens holder 8, the lens holder 8 and the suspension thereof can be viewed as a spring-mass system with certain resonance frequencies. The generation of parasitic oscillations is more effectively suppressed by arranging the actuators such that force is symmetrically applied to the lens holder 8.

An arrangement other than that of FIGS. 1 and 2, wherein the focussing coils 9, 10 are mounted on the support frame and the permanent magnets 12, with or without a yoke, are mounted on the lens holder 8, is also possible. This may be necessary if large currents are needed and heat cannot be effectively transferred from the lens holder 8. However, from the point of actuator control it is desirable to use the arrangement shown in the drawings. The permanent magnet 12 is susceptible to forces generated by stray electromagnetic fields, such as those generated by the disk drive motor 3. If permanent magnets were to be mounted on the lens holder 8, the lens holder 8 would move in an uncontrollable way under the influences of such stray fields. In addition, the shown arrangement is generally lower in weight, making the lens holder 8 more responsive, which is desirable from the point of view of controlling its position and orientation. Furthermore, it has become apparent in practice, that a configuration in which the lens holder 8 carries the coils 9, 10 is more efficient if the heat dissipation can be controlled.

The arrangement of each of the two magnetic circuits formed by the yokes 1 and permanent magnets 12 is very compact and efficient. In the arrangement of the invention, almost all of the flux generated by the permanent magnet 12 is concentrated in the yoke 11 which is made of a material with a high magnetic permeability. The yokes 11 extend through the corresponding focussing coil along its winding axis. As is apparent from the FIGS. 1 and 2, the magnetic circuit comprises an air gap 13. The air gap 13 defines the face of the yoke where the flux leaves the yoke. The windings of the first and second focussing coils 9, 10 thus intersect the flux passing from the face of the yoke through the air gap to the magnet 12. Because the flux is conducted through the center of the coils 9, 10, maximum interaction with the current flowing through the coils 9, 10 is ensured.

According to the invention, the same magnetic circuit is also used for the actuator arrangement used to control movement in the tracking direction y. The magnetic circuit forms a loop in a plane parallel to the focussing direction z and the tangential direction x. The flux is, therefore, also parallel to the tangential direction x at a point in the circuit.

The air gap 13 also provides space for accommodating two radial coils 14 which are mounted side by side in the tracking direction y in the air gap 13 in each magnetic circuit, their winding axis being aligned in the tangential direction x. The radial coils 14 and the magnetic circuit form an actuating arrangement for controlling the position of the lens holder 8 in the tracking direction y. Although it would be possible to use only one radial coil 14, it is preferred to use two, because the magnetic flux through a single radial coil 14 would vary as the lens holder 8 changes position in the tracking direction y. A more elaborate control circuit would be needed to take account of this variation of the magnetic flux density. In the current configuration, as one of the radial coils 14 moves out from between the end faces of the yoke 11 and the permanent magnet 12, the other moves more fully into the air gap 13 for compensation. The total flux through the two radial coils 14 remains substantially the same.

The preferred means whereby the lens holder 8 is suspended in the support frame of the read/write head 6 are formed by four wire members 15. Each is fixed to the lens holder 8 at one end, and to a support frame part 16 at the other end. The wire members 15 are made of a resilient material, which is preferably electrically conductive, e.g. copper, iron, or an alloy.

The wire members 15 limit the number of degrees of freedom of the lens holder 8. Only translations in the tracking direction y and the focussing direction z are possible. Only tilt about the tangent direction x is allowed. In particular, tilt about the focussing direction z and the tracking direction y is not possible.

The wire members 15 are preferably electrically conductive so that they can be used for applying driving currents to the radial coils 14 and the first and second focussing coils 9, 10. Turning to FIG. 3, it will be seen that four wire members 15 exactly suffice for providing the required driving currents. The control circuit (not shown) provides three control signals to the actuator arrangement. A radial coil control signal 17 determines movement in the tracking direction; the direction of the driving current then determines whether this movement is towards or away from the center of the disk 1. A focus control signal 18 controls the focussing of the beam 4 by the objective lens 7 through the position of the lens holder 8 in the focussing direction z. A tilt control signal 19 controls the degree and direction of tilt of the lens holder 8. The tilt control signal 19 is added to the focus control signal 18 for the first focussing coil 9, and subtracted for the second 10, to obtain the driving current. Thus, the first and second focussing coils 9, 10 are provided with different driving currents to enable tilt. The radial coils 14 are all provided with the same driving current. They are, therefore, connected in series. One of the conductive wire members 15 is a common wire whereto the series-connected radial coils 14 and each of the focussing coils 9, 10 are connected at one end. Current to the radial coils 14 is supplied through a second wire member 15. Current to the first and second focussing coils 9, 10 is supplied through a third and a fourth wire member 15.

Preferably, the wire members 15 are provided with a cladding of an elastic, preferably electrically insulating material. Apart from the insulation, the function of the cladding is to dampen any parasitic oscillations of the lens holder 8 which, as mentioned, forms a spring-mass system with the wire member 15. Thus, more accurate positioning is achieved.

The invention is not limited to the above embodiments which may be varied within the scope of the claims. For example, it is not strictly necessary that the lens holder be suspended by rod-shaped wire members. Blades shaped to form hinges could also be used, but would be much stiffer, thus necessitating a larger force to tilt the lens holder. Further, although a single objective lens 7 is used in the described embodiment, the lens holder may comprise a more elaborate optical system for focussing and/or splitting the beam, depending on the complexity of the optical drive.

1. A read and/or write head for an optical disk drive, comprising
a lens holder, a support frame, means for suspending the lens holder in the support frame, which means constrain movement of the lens holder relative to the support frame, allowing only an at least limited translation in a focussing direction (z), parallel to the optical axis of a lens in the lens holder, an at least limited translation in a tracking direction (y), perpendicular to the focussing direction (z), and an at least limited rotation about an axis in a tangent direction (x), perpendicular to both the focussing and the tracking direction, and actuator means, comprising two conductive focussing coils with a winding axis parallel to the focussing direction (z), each positioned relative to a magnetic circuit in such a way that a current flowing through a coil gives rise to a force between the lens holder and the support frame in the focussing direction (z), the winding axes of the two focussing coils being positioned on opposite sides of a plane through the center of mass of the lens holder and parallel to the focussing and tangent direction, characterized in that the focussing coils are spaced apart in the tangent direction (x).

2. A read and/or write head according to claim 1, wherein the distance (d) between each winding axis of a focussing coil and the plane through the center of mass of the lens holder, and parallel to the focussing and the tangent direction, is smaller than the distance from the winding axis to the winding of each focussing coil in a lateral direction parallel to the tangent direction.

3. A read and/or write head according to claim 1, wherein the two focussing coils are point-symmetrically arranged relative to the center of mass of the lens holder.

4. A read and/or write head according to any one of claims 1, wherein the two focussing coils are mounted on the lens holder.

5. A read and/or write head according to claim 1, wherein each magnetic circuit comprises a yoke extending at least partly through the corresponding focussing coil along its winding axis.

6. A read and/or write head according to claim 5, wherein each magnetic circuit forms a loop in a plane parallel to the focussing and the tangential direction and comprises an air gap through which the windings of the corresponding focussing coil can move, at least one radial coil being mounted on the lens holder and located in each air gap with a winding axis aligned with the flux through the magnetic circuit.

7. A read and/or write head according to claim 6, wherein two radial coils are mounted side by side in the tracking direction (y) in the air gap in each magnetic circuit.

8. A read and/or write head according to claim 1, wherein the suspension means comprise four wire members, each attached at one end to the lens holder and at the other end to the support frame.

9. A read and/or-write head according to claim 4, wherein the wire members are of an electrically conducting material and are electrically connected to the coils.

10. A read/write head according to claim 8, wherein the wire members are provided with a cladding of an elastic material.

11. An optical disk drive comprising the read/write head according to claim 1.
